(19) United States
(12) Patent Application Publication
(10) Pub. No.: US 2015/0119062 A1
(43) Pub. Date: Apr. 30, 2015

(54) WIRELESS COMMUNICATION METHOD, SYSTEM AND APPARATUS

(71) Applicant: Kabushiki Kaisha Toshiba, Minato-ku (JP)

(72) Inventors: Tsuguhide AOKI, Kawasaki (JP); Yuji Tohzaka, Kawasaki (JP); Noritaka Deguchi, Yokohama (JP)

(73) Assignee: Kabushiki Kaisha Toshiba, Minato-ku (JP)

(21) Appl. No.: 14/592,716

(22) Filed: Jan. 8, 2015

Related U.S. Application Data
(63) Continuation of application No. PCT/JP2013/058891, filed on Mar. 19, 2013.

(30) Foreign Application Priority Data
Jul. 9, 2012 (JP) 2012-153904

(51) Int. Cl. H04W 72/08

(52) U.S. Cl. CPC H04W 72/082
USPC 455/452.1

(57) ABSTRACT

According to one embodiment, a wireless communication method for improving frequency efficiency is disclosed. The method can transmit a first instruction indicating that the second terminal is allowed to transmit a second data signal at the first frequency if the first signal strength intensity is not more than a threshold and if the second signal strength intensity is not more than a threshold. The method can transmit a second instruction indicating that the second terminal is caused to suspend the second data signal transmission at the first frequency in reference to the first instruction if interference occurring in a first base station as a transmission result of the second data signal is not less than a threshold.

### CROSS-REFERENCE TO RELATED APPLICATIONS

This application is a Continuation application of PCT Application No. PCT/JP2013/058891, filed Mar. 19, 2013 and based upon and claiming the benefit of priority from Japanese Patent Application No. 2012-153904, filed Jul. 9, 2012, the entire contents of all of which are incorporated herein by reference.

### FIELD

Embodiments described herein relate generally to a wireless communication method, system and apparatus.

### BACKGROUND

In recent cellular systems, for example, a long term evolution (LTE) designed by 3GPP, a next-generation PHS (XGP), and WiMAX, adjacent cells use the same frequency band in order to improve frequency utilization efficiency. In such systems, if a frequency division multiple access (FDMA) or an orthogonal frequency division multiple access (OFDMA) is used, interference may result from the use of the same frequency. Hence, base stations use a frequency assignment method referred to as FFR a fractional frequency reuse (FFR).

### BRIEF DESCRIPTION OF THE DRAWINGS

FIG. 1 is a conceptual drawing of a wireless communication system according to a first embodiment;

FIG. 2A is a diagram illustrating frequency bands used by each cells;

FIG. 2B is a conceptual drawing of positional relations between terminals and cells formed by base station;

FIG. 3 is a block diagram illustrating a base station according to a first embodiment;

FIG. 4 is a sequence diagram illustrating operation of the base station according to the first embodiment;

FIG. 5 is a conceptual drawing of a wireless communication system according to a second embodiment;

FIG. 6 is a block diagram illustrating the wireless communication system according to the second embodiment;

FIG. 7 is a sequence diagram illustrating the wireless communication system according to the second embodiment;

FIG. 8 is a block diagram illustrating the base station in a wireless communication system according to a third embodiment;

FIG. 9 is a block diagram illustrating details of an uplink adaptive antenna system (AAS) unit;

FIG. 10 is a diagram illustrating an example of a table stored in an integration unit according to the third embodiment;

FIG. 11 is a flowchart illustrating a determination processing performed by the base station according to the third embodiment;

FIG. 12 is a conceptual drawing illustrating that some base stations are connected to the integration unit, whereas the others are unconnected to the integration unit;

FIG. 13 is a diagram illustrating the relationship between the number of terminals and the value of a determinant;

FIG. 14 is a flowchart illustrating a determination process performed by a base station according to a fourth embodiment;

FIG. 15 is a block diagram illustrating a wireless communication system according to a fifth embodiment;

FIG. 16 is a sequence diagram illustrating operation of the wireless communication system according to the fifth embodiment; and

FIG. 17 is a diagram illustrating an assigned terminal determination method performed by a scheduler.

### DETAILED DESCRIPTION

FFR divides frequencies into those frequencies which are assigned to terminals present at cell edges that are the vicinity of the boundary between cells formed by base stations and those frequencies which are assigned to terminals present in cell centers. For the frequencies assigned to the terminals present in the cell centers, the same frequency is reutilized even for adjacent cells. For the frequencies assigned to the terminals present at the cell edges, the adjacent cells are prevented from being assigned with the same frequency. Thus, the terminals present in the cell centers are far from each other and are thus prevented from suffering from interference. The terminals present at the cell edges are close to each other but are prevented from suffering from interference due to the use of different frequencies.

However, FFR has a problem because different frequencies are assigned to terminals at the cell edge of each cell in order to avoid interference. That is, even if a first terminal and a second terminal are present at respective cell edges that are far from each other and are unlikely to suffer from interference, the same frequency cannot be assigned to these terminals. As a result, many frequencies remain unassigned to any of the terminals. Thus, FFR is not preferred in terms of frequency efficiency.

In general, according to one embodiment, a wireless communication method relating to a first base station and a second base station different from the first base station for improving frequency efficiency is disclosed. The method can measure, by the second base station, a first signal strength intensity of a first data signal transmitted at a first frequency by a first terminal communicating with a first base station, the first signal strength intensity being measured at the second base station. The method can determine, by the second base station, whether or not the first signal strength intensity is not more than a first threshold and whether or not a second signal strength intensity is not more than a second threshold, the second signal strength intensity being obtained if a second terminal communicating with the second base station receives a reference signal transmitted by the first base station. The method can transmit, by the second base station to the second terminal, a first instruction indicating that the second terminal is allowed to transmit a second data signal at the first frequency if the first signal strength intensity is not more than the first threshold and if the second signal strength intensity is not more than the second threshold. The method can store the first instruction in an integration unit connected to the first base station and the second base station. The method can transmit, by the integration unit to the second base station, a second instruction indicating that the second terminal is caused to suspend transmission of the second data signal at the first frequency in reference to the first instruction stored in the integration unit if interference occurring in the first base station is not less than a third threshold, the interference occurring as a result of transmission of the second data signal.

A wireless communication method, system and apparatus according to an embodiment will be described below with reference to the drawings. In embodiments described below, components denoted by the same reference numerals are intended to perform similar operations, and duplicate descriptions are omitted.

### First Embodiment

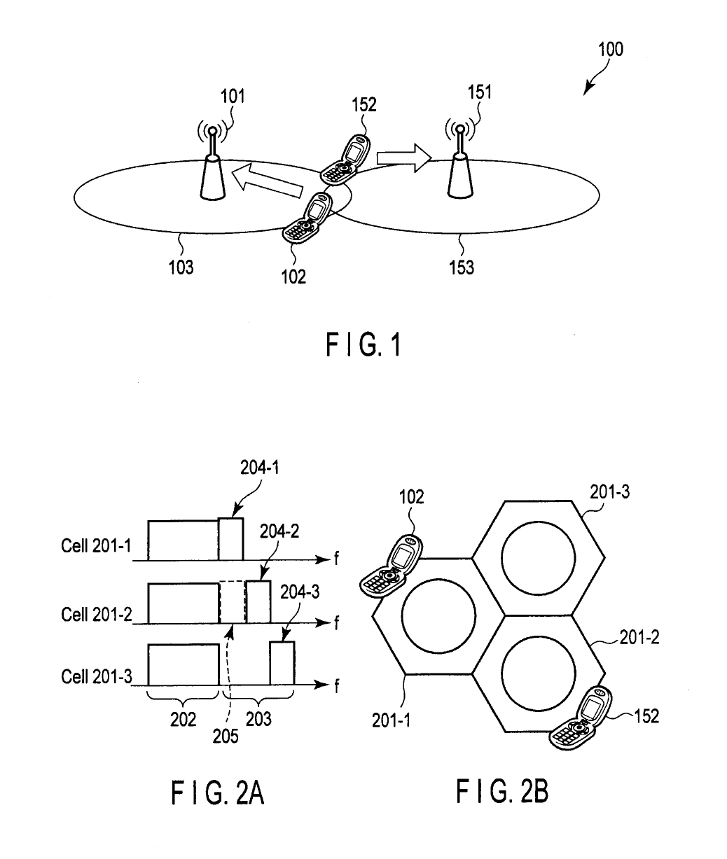

A conceptual drawing of a wireless communication system according to a first embodiment will be described with reference to FIG. 1.

A wireless communication system 100 includes a wireless base station (hereinafter simply referred to as a base station) 101, a base station 151, a wireless terminal (hereinafter simply referred to as a terminal) 102, and a terminal 152. In an example shown in FIG. 1, it is assumed that the base station 101 forms a cell 103, that the base station 151 forms a cell 153, and that the base station 101 and the base station 151 use the same frequency band. The terminal 102 is present within the cell 103 and communicates with the base station 101. Furthermore, the terminal 152 is present within the cell 153 and communicates with the base station 151.

In the present embodiment, an uplink is assumed in the description. Furthermore, for simplification, it is assumed that two base stations are present and that one terminal is present at the cell edge of a cell formed by each of the base stations. However, three or more base stations may be present, and a plurality of terminals may be present at the cell edge. The cell edge refers to the vicinity of the boundary between cells.

Now, the concept of a frequency assignment method according to the present embodiment will be described with reference to FIGS. 2A and 2B.

FIG. 2A shows frequency bands used by respective cells. FIG. 2B shows a conceptual drawing of positional relations between terminals and cells formed by base stations. As shown in FIG. 2B, it is assumed that three cells, a cell 201-1, a cell 201-2, and a cell 201-3 are formed. Furthermore, according to a scheme using FFR, a frequency (hereinafter referred to as a cell center frequency) 202 assigned to terminals present in the centers of cells and a frequency (hereinafter referred to as a cell edge frequency) 203 assigned to terminals present at cell edges are allocated depending on the position of the terminal within the cell.

As seen in FIG. 2A, the cell center frequency 202 is common to the cells 201. The assignment of the cell edge frequency 203 is as follows. For the cell 201-1, a frequency 204-1 is preferentially assigned to terminals as a cell edge frequency. For the cell 201-2, a frequency 204-2 is preferentially assigned to terminals as a cell edge frequency. For the cell 201-3, a frequency 204-3 is preferentially assigned to terminals as a cell edge frequency.

Furthermore, since the terminal 102 and the terminal 152 are present in the different cells 201-1 and 201-2, respectively, basically different cell edge frequencies are assigned to the terminals 102 and 152. According to the present embodiment, when the terminal 102 and the terminal 152 are away from each other as shown in FIG. 2B, even if a cell edge frequency 204-1 is assigned to the terminal 102, the cell edge frequency 204-1, that is, a frequency 205 enclosed by a broken line, can be assigned to the terminal 152.

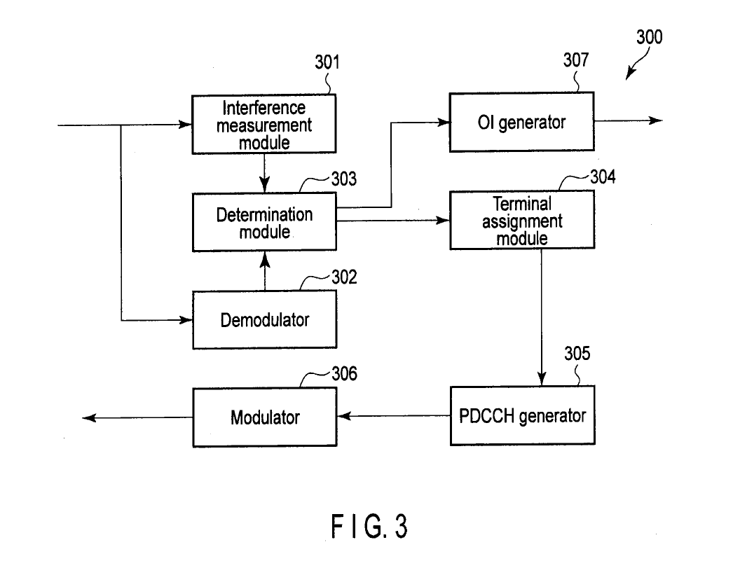

Now, the base station according to the first embodiment will be described with reference to a block diagram in FIG. 3.

A base station 300 according to the first embodiment includes an interference measurement module 301, a demodulator 302, a determination module 303, a terminal assignment module 304, a physical downlink control channel (PDCCH) generator 305, a modulator 306, and an overload indicator (0I) generator 307.

The interference measurement module 301 receives a physical uplink shared channel (PUSCH) transmitted by a terminal belonging to a second cell different from a first cell of the present base station and measures a received signal strength intensity.

The demodulator 302 receives and demodulates the PUSCH transmitted by a terminal belonging to the first cell of the present base station, and extracts Reference Signal Received Power (RSRP). The RSRP will be described below.

The determination module 303 receives the received signal strength intensity from the interference measurement module 301 and receives, from the demodulator 302, RSRP from a terminal belonging to the cell of the base station 300. The determination module 303 determines whether or not the received signal intensity is not more than a threshold and whether or not the value of the RSRP is not more than a threshold. If any terminal belonging to a second cell has a received signal strength intensity not more than the threshold and an RSRP value not more than the threshold and is thus an assignment target terminal, the determination module 303 provides a determination result indicative of this assignment target terminal.

The terminal assignment module 304 receives the determination result from the determination module 303, and generates an instruction to allow the assignment target terminal to transmit data using a cell edge frequency assigned to the terminal belonging to the second cell.

The PDCCH generator 305 receives the instruction from the terminal assignment module 304, and generates a PDCCH to be transmitted to the assignment target terminal.

The modulator 306 receives the PDCCH from the PDCCH generator 305, modulates the PDCCH, and transmits the modulated PDCCH to the outside.

The OI generator 307 receives, from the determination module 303, a determination result indicating that the received signal strength intensity from the terminal belonging to the second cell is higher than the threshold, and transmits an OI indicating that the interference has become stronger.

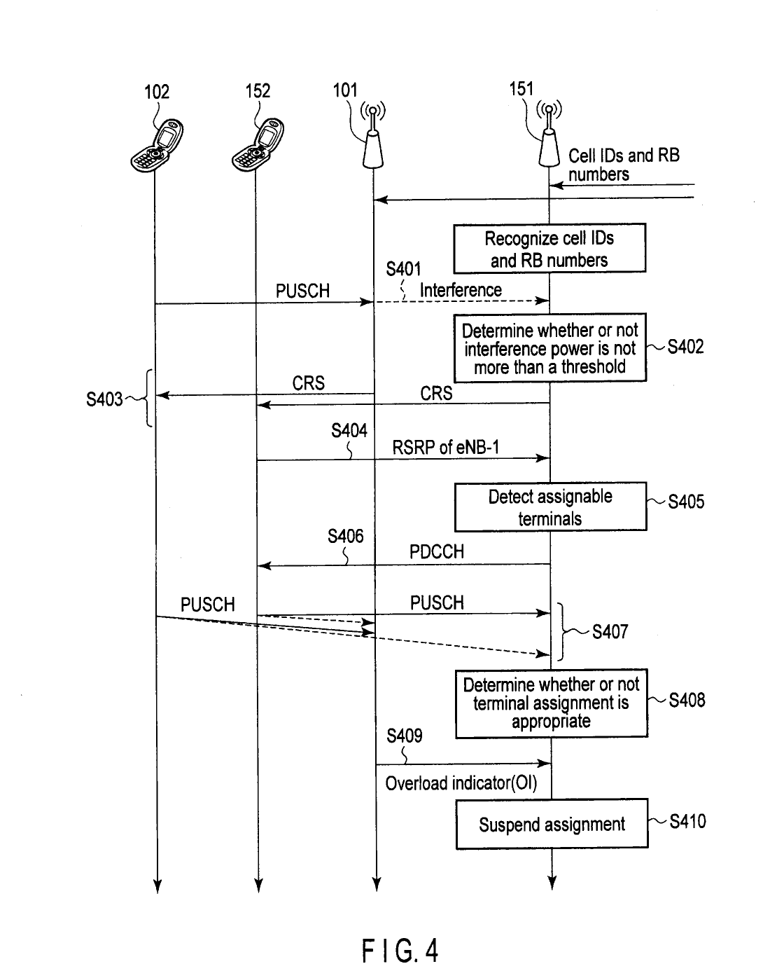

The operation of the base station according to the first embodiment will be described with reference to a sequence diagram in FIG. 4. Here, it is assumed that the base station 101 has assigned a cell edge frequency (hereinafter referred to as other cell edge frequency for convenience) preferentially used for the cell 201-1 to the terminal 102 and that the base station 151 is to assign the same other cell edge frequency as that for the terminal 102 to the terminal 152.

It is assumed that FFR has assigned frequencies to the terminals and that each base station recognizes which frequencies have been assigned to which cells as cell edge frequencies. Specifically, each base station is assumed to know, as the cell edge frequencies, for example, resource block (RB) numbers and the cell IDs of the cells for which the respective frequencies are preferentially used.

In step S401, the interference measurement module 301 of the base station 151 measures the interference power of the frequency used by the terminal 102. The method for measuring the interference power may involve measuring the power of the channel of data transmitted to the base station 101 by the terminal 102. For example, in LTE, the power of the PUSCH may be measured. At this time, the base station 151 has not assigned any other cell edge frequency to the terminal 152 yet, and may thus measure, for example, a received signal strength intensity (RSSI). Alternatively, interference over thermal noise (IoT) or the like may be used.

In step S402, the determination module 303 of the base station 151 determines whether or not the interference power is not more than a threshold. If the interference power is not more than the threshold, the determination module 303 determines that, in the cell of the base station 151, the other cell edge frequency can be assigned to the terminal without any problem. The method thus proceeds to step S403. If the interference power is higher than the threshold, the base station 151 makes searches to determine whether or not another cell edge frequency preferentially used by the second cell is available.

In step S403, the base station 151 and the base station 101 transmit cell specific reference signals (CRSs) that are signals notifying the terminals of reference numbers specific to the cells, to the terminals via a downlink. FIG. 4 shows an example that the CRSs are transmitted at a timing corresponding to step S403. However, the CRSs are periodically transmitted by the terminals.

In step S404, the terminal 152 transmits an RSRP that is a signal indicating the received power of the CRSs received by the terminal from the base stations, to the base station to which the terminal 152 is connected. Since the CRSs are periodically transmitted, the RSRP need not be transmitted during this step but may be transmitted at any time.

In step S405, the terminal assignment module 304 of the base station 151 determines whether any of the terminals present in the cell of the base station 151 is an assignment target terminal which doesn't interfere with transmission carried out by the terminal 102 and which can be assigned with the second cell edge frequency. The method for detecting an assignment target terminal involves, for example, comparing the value of the RSRP with the threshold for each terminal and proceeding to step S406 if the value of the RSRP is not more than the threshold. If the value of the RSRP is larger than the threshold, the base station 151 detects another assignment target terminal or suspends the assignment of the second cell edge frequency. Here, it is assumed that the terminal 152 has been detected as an assignment target terminal.

In step 406, in order to assign the other cell edge frequency to the terminal 152, the terminal assignment module 304 of the base station 151 generates an instruction to allow the terminal 152 to transmit the data at the second cell edge frequency. The PDCCH generator 305 generates and transmits a PDCCH to the terminal 152.

In step S407, at a timing indicated by the PDCCH, the terminal 151 transmits data at the second cell edge frequency. The terminal 152 may transmit data via the PUSCH. The PUSCH reaches not only the base station 151, which is a connection destination, but also the base station 101. Here, it is assumed that the terminal 102 transmits the PUSCH to the base station 101 via the other cell edge frequency preferentially assigned to the terminal 102.

In step S408, the base station 101 and the base station 151 determine, based on a PUSCH receiving state, whether or not the assignment of the terminal 152 to the other cell edge frequency is appropriate. Specifically, each of the determination modules 303 of the base station 101 and the base station 151 measures the interference power of the cell edge frequency to be assigned to the cell edge of the base station to determine whether or not the value of the interference power is larger than the threshold. If the power of the interference power is not more than the threshold, the determination module 303 determines that the assignment is appropriate, and the processing continues. If the power of the interference power is greater than the threshold, the method proceeds to step S409.

In step S409, the overload indicator generator 306 of the base station 101 notifies the surrounding base stations including the base station 151 of the OI, specified in LTE. Thus, each of the base stations can know that the assignment of the other cell edge frequency to the terminal 152 by the base station 152 is inappropriate.

In step S410, the base station 151 suspends the assignment of the terminal 152 to the second cell edge frequency. Thus, the operation of the base station according to the first embodiment ends.

In step S409 and step S410, the base station 151 receives the OI from the base station 101 and suspends the assignment of the assignment target terminal to the second cell edge frequency. However, the determination module 303 of the base station 151 may measure the interference power. The base station 151 may suspend the assignment of the assignment target terminal to the other cell edge frequency if the value of the interference power is larger than the threshold.

According to first embodiment described above, detecting a combination of terminals that is prevented from interfering with each other, allowing the frequency assigned for the cell edge of the second cell to be used for another cell. The first embodiment can thus increase the frequency utilization efficiency, while avoiding interference with the terminal belonging to the second cell to which the cell edge frequency is preferentially assigned.

### Second Embodiment

According to the first embodiment, the base station notifies the surrounding base stations of the OI indicating that the interference has become stronger. A second embodiment is different from the first embodiment in that an integration unit connected to each base station transmits an OI instruction to a base station that has assigned a second cell edge frequency.

According to the first embodiment, after other cell edge frequency is assigned, if interference with a terminal belonging to a second cell to which the other cell edge frequency has been preferentially assigned becomes stronger, which base station has made the interference stronger by its assignment process is unknown. Thus, the surrounding base stations need to be notified of the OI. Thus, OI overhead increases to restrict the use of the other cell edge frequency in all the surrounding cells. On the other hand, according to the second embodiment, the integration unit that manages assignment information for each cell can identify a base station having carried out assignment that makes the interference stronger and transmit the OI to this base station. This allows the restriction of the use of the frequency to be limited, enabling a reduction in OI overhead.

A conceptual drawing of a wireless communication system according to the second embodiment will be described with reference to FIG. 5.

A wireless communication system 500 according to the second embodiment includes a base station 101, a base station 151, a terminal 102, a terminal 152, and an integration unit 501. The base station 101, the base station 151, the terminal 102, and the terminal 152 perform communication almost similar to the communication according to the first embodiment.

The integration unit 501 is connected to the base station 101 and the base station 151, and manages assignment information indicating which frequency has been assigned to which terminal, to control communication. Specifically, the assignment information includes, for example, cell IDs, information on frequencies assigned to the cells, and information on frequencies assigned as second cell edge frequencies and the terminals to which the second cell edge frequencies have been assigned.

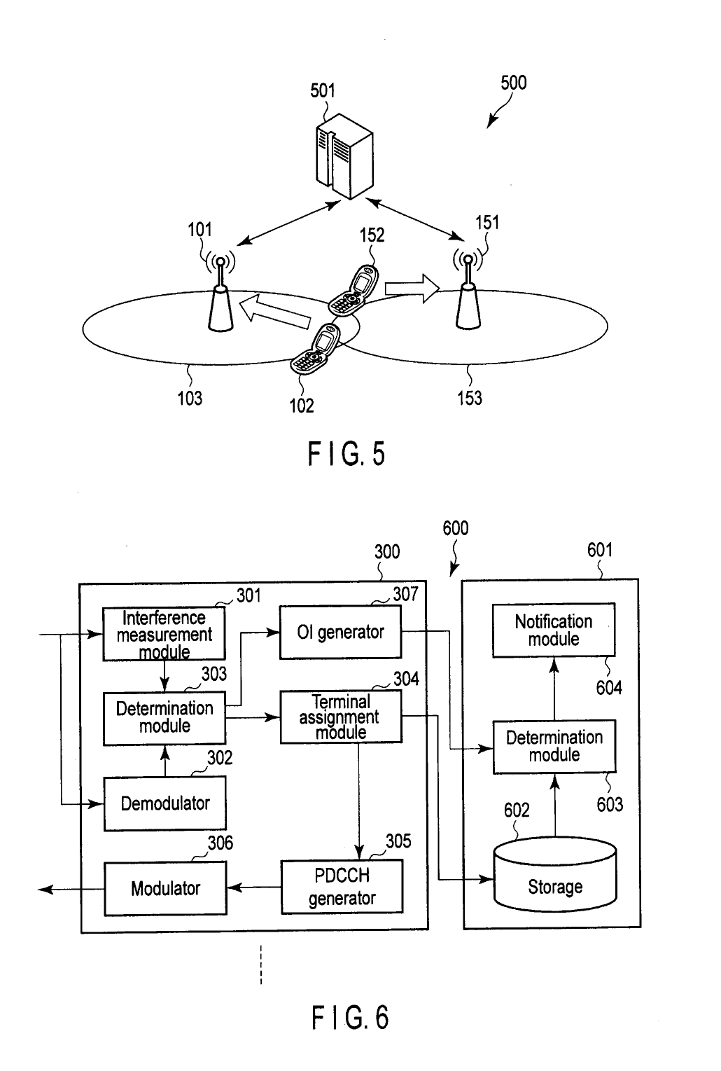

The wireless communication system according to the second embodiment will be described with reference to a block diagram in FIG. 6.

A wireless communication system 600 according to the second embodiment includes a base station 300 and an integration unit 601.

The base station 300 is almost similar to the base station shown in FIG. 3 except that a terminal assignment module 304 transmits assignment information to the integration unit and that an OI generator 307 transmits a generated OI to the integration unit instead of the other base stations.

The integration unit 601 includes a storage 602, a determination module 602, and a notification module 604.

The storage 602 receives assignment information from the base station 101 and the base station 151 and stores the assignment information therein. Furthermore, FFR prestores, in the storage 602, cell IDs that are the identifiers of the cells of the base stations and information on the cell edge frequencies used for the cells. An example of the information on the cell edge frequencies is resource block (RB) numbers.

If the determination module 603 receives the OI from the base stations, the determination module 603 refers to the assignment information stored in the storage 602 to determine which of the base stations has carried out an inappropriate assignment. The determination module 603 then extracts the ID of the base station having carried out the inappropriate assignment.

The notification module 604 notifies each base station of the cell IDs and the information on the cell edge frequencies. Furthermore, the notification module 604 receives, from the determination module 603, the ID of the base station having carried out the inappropriate assignment, and transmits an instruction to suspend the assignment of the second cell edge frequency, to the base station indicated by the ID.

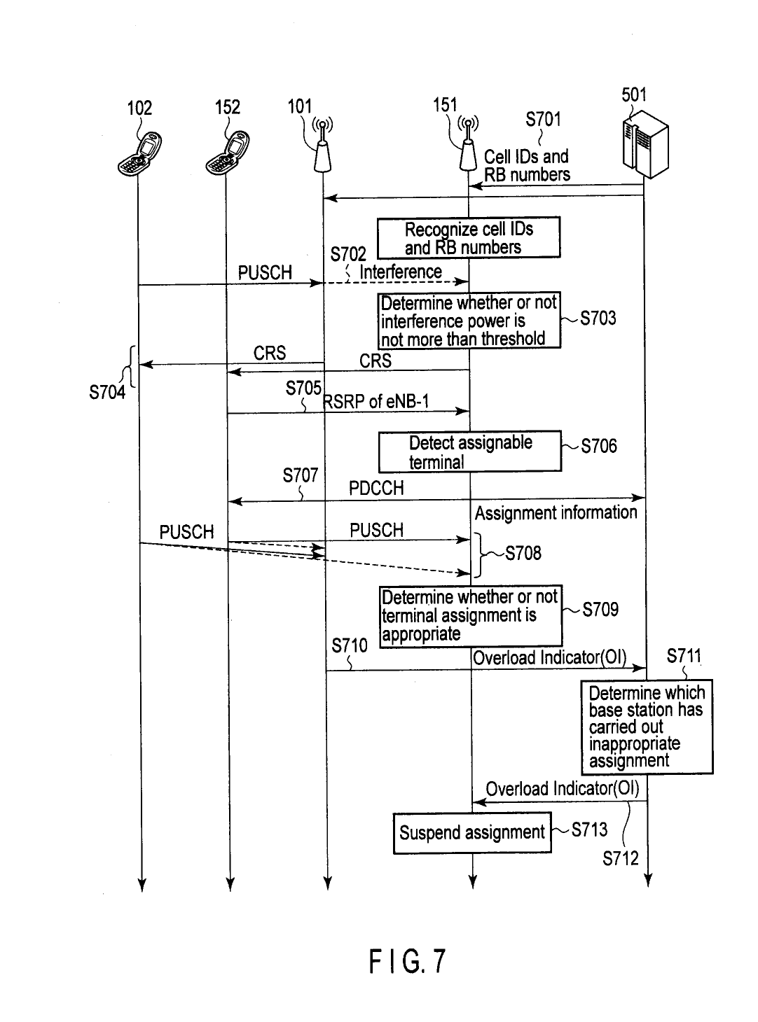

Now, the wireless communication system according to the second embodiment will be described with reference to a flowchart in FIG. 7. As in the case of FIG. 4, it is assumed that the base station 101 has preferentially assigned a cell edge frequency for a cell 103 to the terminal 102 and that the base station 151 is to assign the same other cell edge frequency as that for the terminal 102 to the terminal 152.

In step S701, the integration unit 501 transmits cell IDs that are the identifiers of the cells of the base stations and information on the cell edge frequencies used for the cells. The information on the cell edge frequencies is, for example, resource block (RB) numbers.

Step S702 to step S706 are similar to step S401 to step S405 shown in FIG. 4 and will thus not be described.

In step S707, the base station 151 transmits, to the terminal 152, a PDCCH containing an instruction to assign other cell edge frequency to the terminal 152. The base station 151 transmits assignment information indicating that the terminal 152 has been assigned, to the integration unit 501. The storage 602 of the integration unit 501 receives and stores the assignment information.

The notification to the integration unit 501 need not be simultaneous with the transmission of a PDCCH from the base station 151 to the terminal 152 but may be before or after the transmission.

Step S708 and step S709 are similar to step S407 to step S408 shown in FIG. 4 and will thus not be described.

In step S710, the base station 101 notifies the integration unit 501 of an OI indicating that the interference has become stronger at the cell edge frequency. The base station 151 may transmit another signal containing information on the interference at each cell edge frequency to the integration unit 501.

In step S711, if the determination module 603 of the integration unit 501 receives a signal containing the OI or equivalent information, the determination module 603 determines for each cell whether or not another terminal has assigned the terminal to the other cell edge frequency before the reception of the OI. If another base station has assigned the terminal to the second cell edge frequency, the method proceeds to step S711. If no other base station has assigned the terminal to the second cell edge frequency, the determination module 603 carries out similar determination on a cell edge frequency for another cell. Here, in step S707, since the determination module 603 of the integration unit 501 has been notified of information indicating that base station 151 has assigned other cell edge frequency to the terminal 152, the determination module 603 can determine the assignment process carried out by the base station 151 to be inappropriate.

In step S712, the notification module 604 of the integration unit 501 notifies the base station 151 of the OI. The present embodiment is not limited to the OI, but any information may be used which is indicative of the status of the interference at each cell edge frequency.

In step S713, the base station 151, having received the OI or equivalent information from the integration unit 501, assigns a terminal different from the terminal 151 to the other cell edge frequency or suspends the terminal assignment to the second cell edge frequency.

The second embodiment has been described in conjunction with the case where the frequency (RB) preferentially assigned as a cell edge frequency for each cell is fixed. However, the second embodiment is not limited to this, and the frequency may be dynamically set. For example, for each base station, if the cell edge frequency preferentially used for the cell of the base station is to be changed, the base station notifies the integration unit 501 of the desired frequency to be used as a cell edge frequency. The notification may use, for example, an HII (High Interference Indicator) specified in LTE or a signal with a function similar to that of the HII. The integration unit receives the HII or a signal with a similar function. Then, if the frequency desired as a cell edge frequency is preferentially used for another cell, the integration unit transmits information indicating that the desired frequency is unavailable to the base station having transmitted the HII. The information may be the OI or an equivalent signal. This allows the frequency assigned for the cell edge of each cell to be dynamically varied without being used in a duplicate manner.

According to the second embodiment described above, the integration unit, which manages the assignment information for each cell, can identify a base station having carried out assignment that makes the interference stronger and transmit the overload indicator to this base station. Thus, the restriction of the use of the frequency can be limited, enabling a reduction in overhead caused by broadcasting of the OI.

### Third Embodiment

A third embodiment is different from the first and second embodiments in that each base station includes an AAS which enables antenna directionality to be digitally controlled using a plurality of antennas. The AAS is characterized by being able to reduce interference using a plurality of antennas. The interference can be reduced to a degree equal to “the number of antennas minus 1” (this is referred to as the degree of freedom), and thus, as many terminals as the antennas can be multiplexed at the same frequency. The interference can be reduced without depending on a received power level, and thus, even interference with high interference power can be reduced if the power is not more than the degree of freedom. The number of antennas in each base station is hereinafter assumed to be 2.

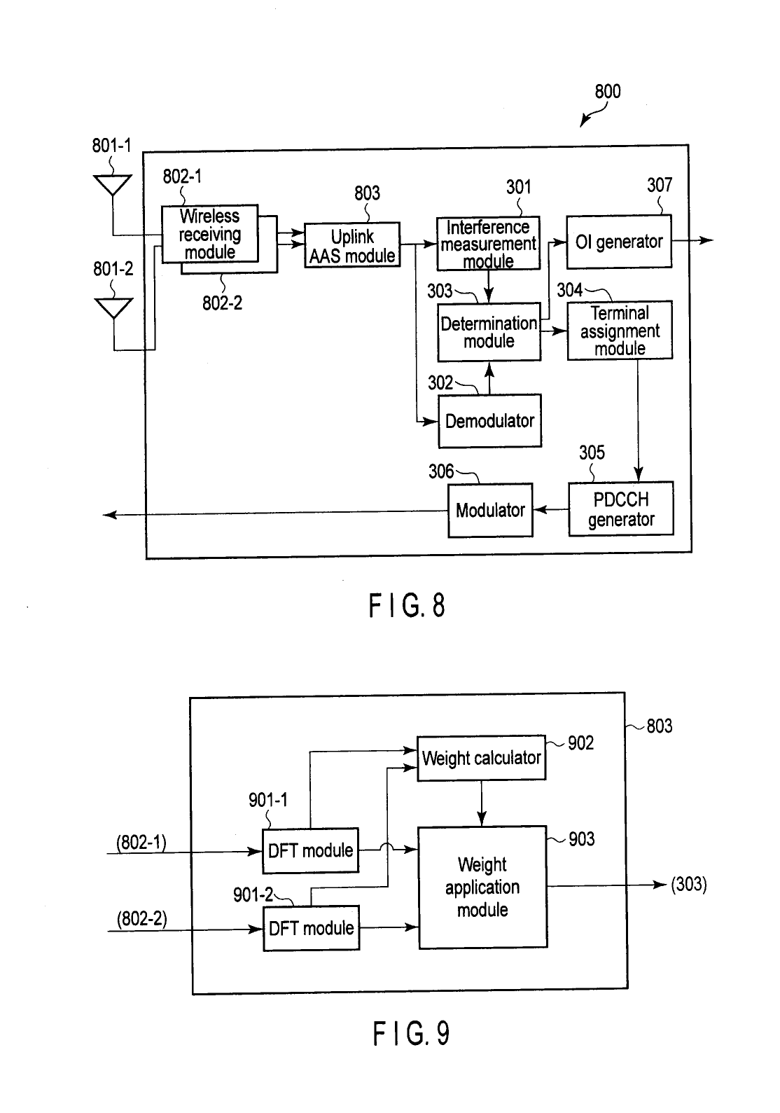

A base station in a wireless communication system according to the third embodiment will be described with reference to a block diagram in FIG. 8.

A base station 800 according to the third embodiment includes an interference measurement module 301, a demodulator 302, a determination module 303, a terminal assignment module 304, a PDCCH generator 305, a modulator 306, an OI generator 307, an antenna 801-1, an antenna 801-2, a wireless receiving module 802-1, a wireless receiving module 802-2, and an uplink AAS module 803.

The interference measurement module 301, the demodulator 302, the determination module 303, the terminal assignment module 304, the PDCCH generator 305, the modulator 306, and the OI generator 307 perform processing similar to the processing in the first embodiment and will thus not described below.

The antennas 801-1 and the antenna 801-2 receive external signals to obtain received signals.

The wireless receiving module 802-1 and the wireless receiving module 802-2 receive received signals from the antenna 801-1 and the antenna 801-2, respectively, and perform signal processing on the received signals to obtain digital received signals. Here, the signal processing is general signal processing and includes, for example, downconverting, filtering, amplification, and AD conversion.

The uplink AAS module 803 receives the digital received signals from the wireless receiving module 802-1 and the wireless receiving module 802-2, and carries out an interference reduction AAS process on the signals to obtain digital signals with interference reduced.

The uplink AAS module 803 will be described in detail with reference to a block diagram in FIG. 9.

The uplink AAS module 803 includes a DFT module 901-1, a DFT module 901-2, a weight calculator 902, and a weight application module 903.

The DFT module 901-1 and the DFT module 901-2 receive the digital received signals from the wireless receiving module 802-1 and the wireless receiving module 802-2, respectively, and perform discrete Fourier transformation on the digital received signals. The DFT process need not necessarily be followed by the AAS process. However, LTE designs the system based on signal processing on a frequency basis, and thus, the embodiment assumes processing on the frequency basis with the DFT applied thereto.

The weight calculator 902 receives the digital received signals from the DFT module 901-1 and the DFT module 901-2, and calculates a weight value for the uplink AAS.

The weight application module 903 receives the weight value from the weight calculator 902 and the DFT-processed digital received signals from the DFT module 901-1 and the DFT module 901-2. The weight application module 903 applies the weight value to the DFT-processed digital received signals to obtain AAS-processed signals, and passes the signals to the succeeding demodulator 302.

A specific weight calculation process will be described.

The received signals received by the antenna 801-1 and the antenna 801-2 are denoted by x₁ and x₂, respectively, and a vector into which the received signals are combined is expressed by x=[x₁, x₂]T. The weight for the uplink AAS can be calculated as follows.

wᵣₓ=Rₓₓ⁻¹rₓᵣ (1)

In this case, Rₓₓ and rₓᵣ are a correlation matrix and a correlation vector for a reference signal and can be expressed as follows.

Rₓₓ=E(xx^{H}) (2)

rₓᵣ=E(xd*) (3)

Here, d denotes a reference signal unaffected by a propagation channel or noise, and E( ) denotes an ensemble average. The ensemble average cannot actually be calculated, and may thus be replaced with an average on the time axis or the frequency axis which does not significantly vary. Furthermore, in each variable, ( )^{H} denotes complex transpose, ( )* denotes complex conjugation, and ( )^{T} denotes transpose.

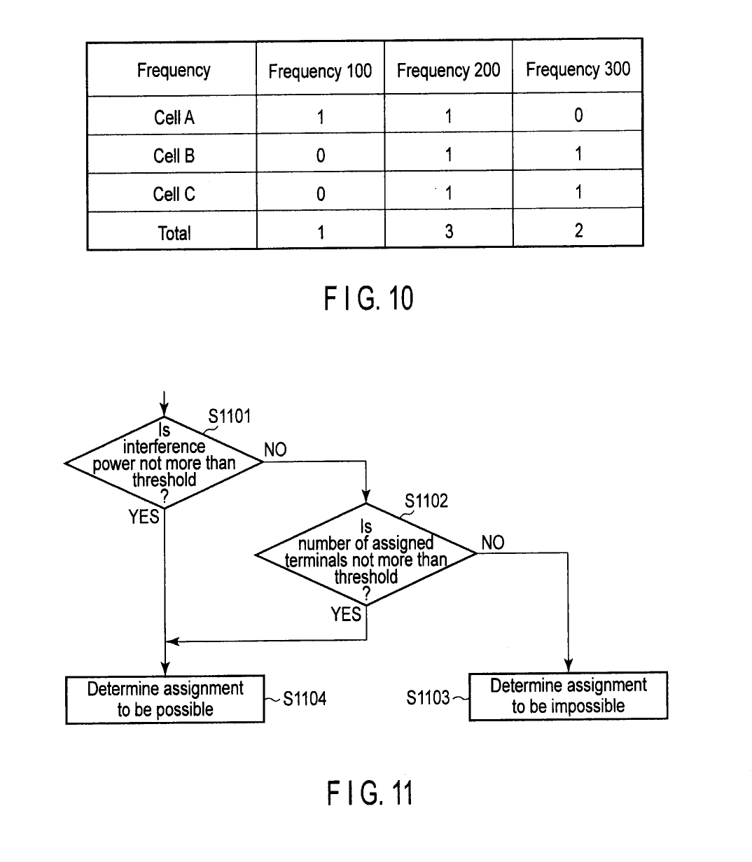

An example of a table stored in a storage of an integration unit according to the third embodiment will be described with reference to FIG. 10.

The table in FIG. 10 shows how many terminals are assigned to each frequency in each cell (each base station). The table is generated based on the assignment information from each base station and stored in a storage 602. By way of a specific example, a frequency 100 is assigned to one terminal in a cell A, and a frequency 200 is assigned to one terminal in each of the cell A, a cell B, and a cell C. That is, even if, for example, the cell A causes strong interference, since the number of terminals assigned to the frequency 100 is “1”, the frequency 100 can be assigned to the terminal if the base station includes a 2-antenna ASS.

The operation of the wireless communication system according to the third embodiment is almost similar to the operation of the wireless communication system according to the second embodiment shown in FIG. 7 except for step 703.

A determination process carried out by the base station in step S703 according to the third embodiment will be described with reference to a flowchart in FIG. 11.

In step S1101, the base station determines whether the interference power is not more than a threshold. If the interference power is not more than the threshold, the process proceeds to step S1104. If the interference power is higher than the threshold, the process proceeds to step S1102.

In step S1102, the base station determines whether or not the number of terminals assigned to the cell edge frequencies for the surrounding cells is not more than a threshold. If the number of assigned terminals is not more than the threshold, the process proceeds to step S1104. If the number of assigned terminals is larger than a threshold, the process proceeds to step S1103.

In step S1103, the base station determines the terminal assignment to be impossible.

In step S1104, the base station determines the terminal assignment to be possible. For example, an integration unit 501 notifies a base station 151 of information indicative of the possibility of assigning the cell edge frequency. Then, the processing in step S703 ends. Thus, if the base station includes an AAS and the interference power is high but more than the degree of freedom, the integration unit 501 can assign the terminal to the cell edge frequency.

If the integration unit 501 notifies each base station of the number of terminals assigned to the cell edge frequencies for the surrounding cells, the notification may be carried out when the table is created or each base station may be notified of the number after the processing in step S703.

FIG. 10 shows an example of a table created by aggregating assignment information from the base stations. However, results of determination by the base station which are indicative the possibility of assigning the cell edge frequency may be used to notify the integration unit of the “assignment possibility” so that the integration unit can generate a table based on the “assignment possibility”. That is, the integration unit may be notified of the results of determination indicative the possibility of assigning the cell edge frequency and may store, for example, “1” in the table for the assignment possibility. Thus, at the timing corresponding to step S706 in which each base station determines the assignment, whether or not the assignment is possible can be determined taking the degree of freedom in the AAS into account. This enables minimization of the difference between the table stored in the integration unit and the actual assignment results.

According to the third embodiment described above, even with high interference power received, if the number of interference signals, that is, the number of terminals, is not more than the degree of freedom, the base station with an AAS can multiplex users at the corresponding frequency.

### Fourth Embodiment

A fourth embodiment is different from the above-described embodiments in that base stations connected to the integration unit and base stations unconnected to the integration unit are taken into account. According to the fourth embodiment, even if a base station is unconnected to the integration unit, a frequency used for the cell edge of a cell different from the cell of this base station can be assigned to an assignable terminal. This enables the frequency utilization efficiency to be improved.

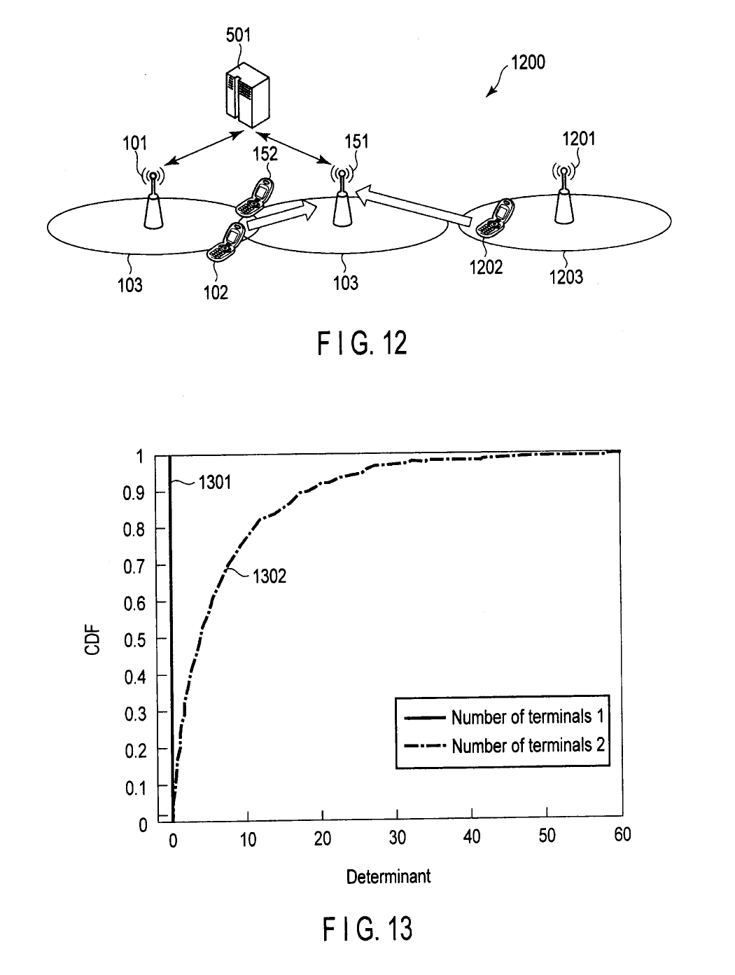

An example in which some base stations are connected to the integration unit, whereas the others are unconnected to the integration unit will be described with reference to FIG. 12.

FIG. 12 shows a wireless communication system 1200 assumed in the fourth embodiment. The wireless communication system 1200 includes not only the wireless communication system 500 according to the second embodiment shown in FIG. 5 but also a base station 1201 unconnected to the integration unit 501 and a terminal 1202 which is present in a cell 1203 formed by the base station 1201 and which is connected to the base station 1201.

Here, it is assumed that a terminal 102 connected to a base station 101 is using a frequency 100 and that the terminal 1202 connected to the base station 1201 is also using the frequency 100. At this time, since the base station 1201 is unconnected to the integration unit 501, terminal assignment information on the cell 1203 is not stored in the table shown in FIG. 10 described above. When the table is simply referred to, to compare the terminals assigned to the frequency 100 with the number of antennas in a base station 151, even if the base station 151 is subjected to strong interference from the terminal 1202, the base station 151 may assign a terminal 152 to the frequency 100 without being aware of the presence of the terminal 1201. If the frequency 100 is assigned to the terminal 152, the total number of the assigned terminals is 3, which exceeds the degree of freedom. As a result, a packet error may occur depending on the interference.

Thus, according to the fourth embodiment, the demodulator of the base station calculates a correlation matrix, and uses information obtained from the correlation matrix to determine whether or not the base station has a capacity to accommodate a further terminal. Specifically, the information obtained from the correlation matrix is, for example, the value of a determinant of the correlation matrix. In general, the correlation matrix is calculated for signal demodulation if any terminal is assigned in the cell of the base station. However, the fourth embodiment calculates the correlation matrix even for frequencies to which no terminal has been assigned.

The relation between the number of terminals and the determinant will be described with reference to FIG. 13.

In FIG. 13, the horizontal axis represents the value of a determinant for an AAS, and the vertical axis represents a cumulative density function (CDF) for the determinant. FIG. 13 also shows a graph 1301 for one terminal and a graph 1302 for two terminals. The determinant of the correlation matrix has been found to have a large value if the number of terminals is not less than the number of antennas and to have a small value if the number of terminals is not more than the number of antennas.

As shown in FIG. 13, if the base station is receiving signals from two terminals, the determinant has a somewhat large value. However, if the base station is receiving a signal from one terminal, the determinant has a small value. Hence, when a threshold (for example, 0.5) is set for the value of the determinant, the number of terminals is 2 if the value of the determinant is larger than the threshold. Then, the base station can determine that the base station does not have a capacity to accommodate a further terminal. On the other hand, if the value of the determinant is not more than the threshold, the number of terminals is 1. Then, the base station can determine that it is likely that a further terminal can be added to the cell.

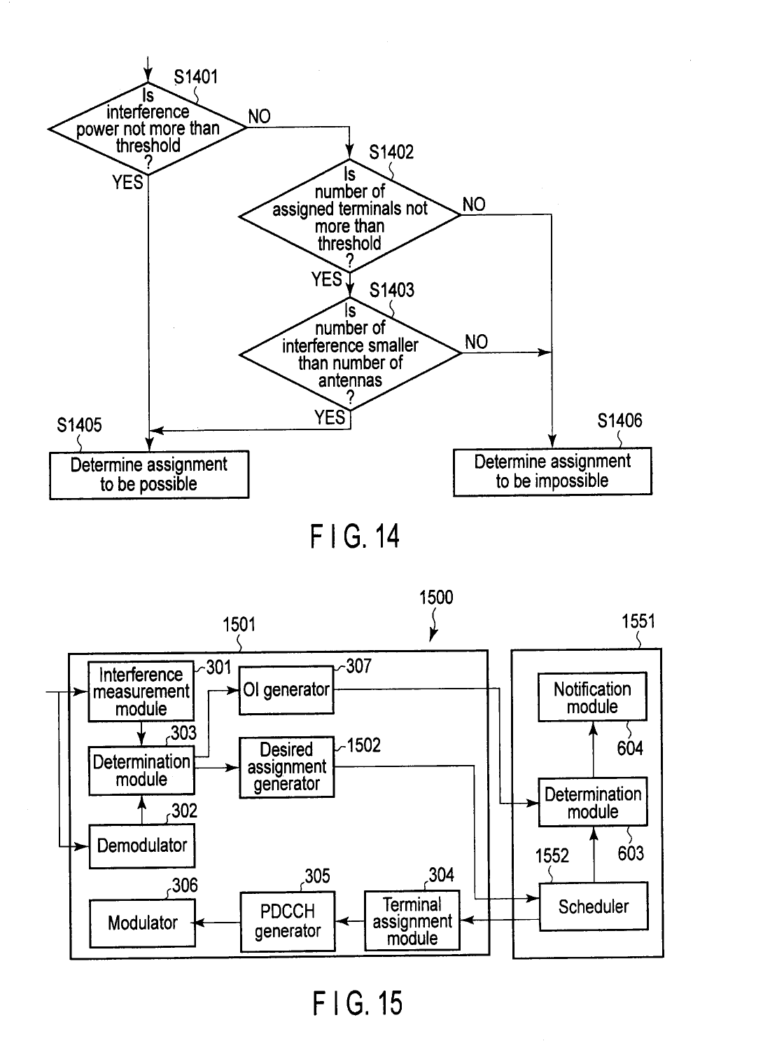

A determination process carried out by the base station in step S703 according to the fourth embodiment will be described with reference to a flowchart in FIG. 14.

In step S1401, a determination module 303 of the base station determines whether or not the interference power is not more than a threshold. If the interference power is not more than the threshold, the process proceeds to step S1402. If the interference power is higher than the threshold, the process proceeds to step S1405.

In step S1402, the determination module 303 of the base station determines whether or not the number of assigned terminals known by the integration unit is not more than a threshold. The determination may be made based on a notification from the integration unit indicating the number of terminals assigned to the cell edge frequencies of the surrounding cells. If the number of assigned terminals known by the integration unit is not more than the threshold, the process proceeds to step S1403. If the number of assigned terminals known by the integration unit is larger than the threshold, the process proceeds to step S1404.

In step S1403, the determination module 303 determines whether or not the number of interference signals received by the base station is smaller than the number of antennas, that is, whether or not the value of the determinant is not more than a threshold. If the number of interference signals received by the base station is smaller than the number of antennas, the process proceeds to step S1405. If the number of interference signals received by the base station is not less than the number of antennas, the process proceeds to step S1404.

In step S1404, the determination module 303 determines the terminal assignment to be impossible.

In step S1405, the determination module 303 determines the terminal assignment to be possible. Then, the base station ends the determination process in step S402.

The fourth embodiment determines the number of interference signals from the determinant of the correlation matrix. However, the method for determining the number of interference signals from the correlation matrix is not limited to this. For example, eigenvalue decomposition may be carried out to calculate the eigenvalue of the correlation matrix so that the number of interference signals can be determined from the magnitude of the eigenvalue.

Furthermore, the fourth embodiment uses the value of the determinant to determine the number of interference signals from a base station unconnected to the integration unit. However, the value of the determinant may be used to determine the number of interference signals from a base station connected to the integration unit. The fourth embodiment also determines the number of interference signals from a correlation matrix for a case where the base station has not carried out terminal assignment. However, as indicated by Equation (1) to Equation (3), the number of interference signals may be determined using a correlation matrix calculated by the AAS and applied for demodulation of a signal from a user assigned by the base station.

Moreover, when the weight of the AAS is calculated, Equation (1) may be calculated after certain values are added to the diagonal components of Equation (2) to provide Expression (2) with an inverse matrix, that is, after the determinant of Equation (2) is forcibly increased in size (this method is also referred to as diagonal loading). At this time, the determinant of a correlation matrix obtained with the values added to the diagonal components of Equation (2) has an obviously large value. Thus, the determinant is desirably calculated from the value of a correlation matrix obtained before the addition of the values to the diagonal components of Equation (2).

Moreover, the embodiments have been described based on FFR, but are applicable based on soft frequency reuse (SFR).

In initialization, SFR assign terminals to all the frequencies. SFR avoids interference by refraining from assigning a frequency assigned to a terminal present at the cell edge of a certain cell to a terminal present at the cell edge of another cell. However, SFR does not always ensure that the system is prevented from being affected by interference, and thus, the terminals at the cell edges may be subjected to interference. Hence, if, for example, a preferential frequency preferentially used for a terminal at the cell edge of a first cell is used for a second cell, the integration unit is notified of a value corresponding to information on the propagation path between the first cell and the assignment target terminal in the second cell, for example, notified of the RSRP. If the interference with the terminal present at the cell edge of the first cell becomes stronger, the integration unit gives a resource release instruction to a base station forming a cell in which one of the terminals assigned in the cells other than the first cell and using the corresponding frequency which terminal has the largest RSRP is present, that is, the terminal likely to interfere with the first cell. Alternatively, each cell may notify the integration unit of, instead of the value of the RSRP, 1-bit signal indicating whether or not the RSRP of any assigned terminal has exceeded a threshold.

Once the resource is released, the base station may reassign the user by performing such steps as described above in the embodiments to add the terminal. Moreover, the embodiments have been described in conjunction with the method for adding and assigning a terminal in a certain cell to a preferential frequency for the cell edge of another cell. However, a frequency with the priority need not necessarily be assigned a terminal at the cell edge. A terminal in the cell center may be assigned and provided with the priority and used for assignment for another cell.

The fourth embodiment described above determines the value of a determinant from a correlation matrix for the AAS. Thus, even if any terminal connected to a base station unconnected to the integration unit causes interference, whether a further terminal can be added can be determined. The fourth embodiment can thus improve the frequency utilization efficiency while avoiding interference.

### Fifth Embodiment

According to the above-described embodiments, the base station determines whether or not a cell edge frequency for one cell is to be assigned a terminal present in another cell. A fifth embodiment is different from the above-described embodiments in that the integration unit collects terminal assignments desired by the base stations, that is, the results of scheduling desired by the base stations, and determines the terminal assignment taking the status of interference among the terminals into account.

A wireless communication system according to the fifth embodiment will be described with a block diagram in FIG. 15.

A wireless communication system 1500 according to the fifth embodiment includes a base station 1501 and an integration unit 1551.

The base station 1501 includes an interference measurement module 301, a demodulator 302, a determination module 303, a terminal assignment module 304, a PDCCH generator 305, a modulator 306, an OI generator 307, and a desired assignment generator 1502. The interference measurement module 301, the demodulator 302, the determination module 303, the PDCCH generator 305, the modulator 306, and the OI generator 307 perform similar operations and will thus not be described below.

The desired assignment generator 1502 receives determination results from the determination module 303 to generate temporary assignment results.

The terminal assignment module 304 performs an operation almost similar to the operation in the above-described embodiments except that the terminal assignment module 304 receives assignment information from the integration unit 1551 and assigns other cell edge frequency to a terminal according to the assignment information.

The integration unit 1551 includes a determination module 603, a notification module 604, and a scheduling unit 1552. The determination module 603 and the notification module 604 perform operations similar to the operations in the second embodiment and will thus not be described below.

The scheduling unit 1552 receives the temporary assignment results from the base station 1501 to determine assignment terminals to which frequencies can actually be assigned.

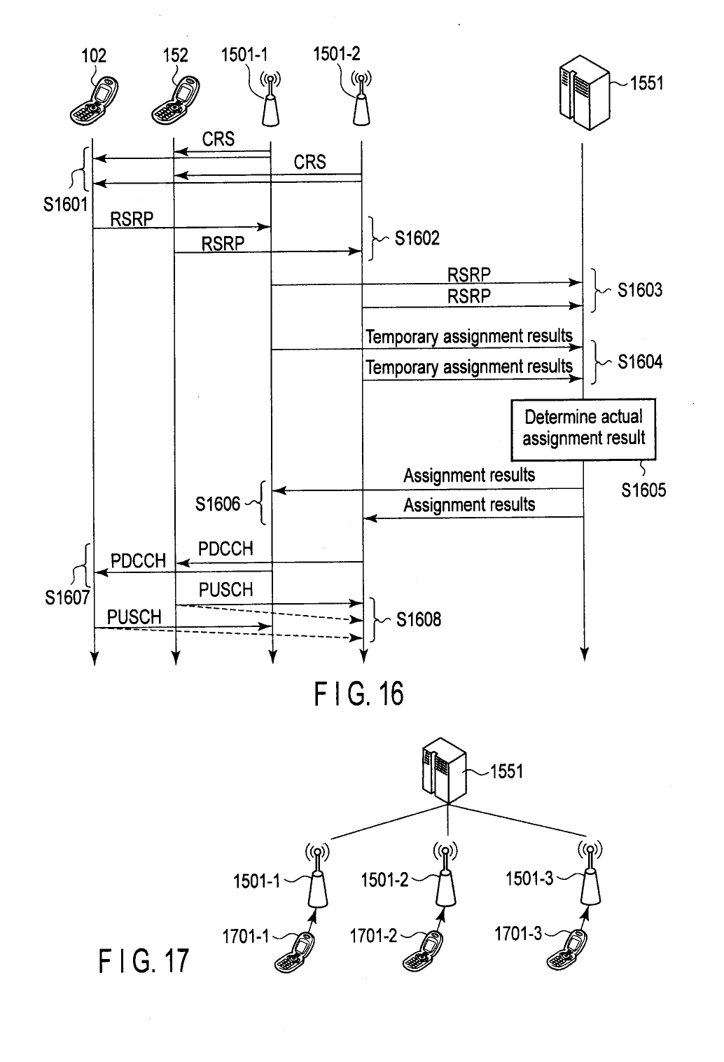

The operation of the wireless communication system according to the fifth embodiment will be described with reference to a sequence diagram in FIG. 16.

In step S1601 and step S1602, processing similar to that in step S704 and step S705 is carried out. Thus, description of these steps is omitted.

In step S1603, the base station 1501 transmits the value of the RSRP to the integration unit 1551.

In step S1604, the desired assignment generator 1502 of the base station 1501 transmits information on the terminals to be assigned by the base station 1501 to the integration unit 1551 as temporary assignment results.

In step S1605, the scheduling unit 1552 of the integration unit 1551 determines the assignment terminals to which the frequencies can actually be assigned.

In step S1606, the integration unit 1551 transmits assignment results including information on the assignment terminals to each base station 1501.

In step S1607, a base station 1501-1 and a base station 1501-2 transmit PDCCHs to a terminal 102 and a terminal 151, respectively, in accordance with the assignment results received from the integration unit 1551.

In step S1607, each terminal transmits data at the assigned frequency. Then, the wireless communication system ends its operation.

A terminal determination method carried out by the scheduling unit 1552 will be described with reference to FIG. 17.

The base stations 1501-1 and 1501-2 and a base station 1501-3 are connected to the integration unit 1551, and terminals 1701-1, 1701-2, and 1701-3 are connected to the respective base stations.

First, a case where the base station includes no AAS will be described.

On the assumption that the terminal 1701-1 has the highest priority, the integration unit 1551 determines that a frequency is to be assigned to the terminal 1701. The integration unit 1551 then determines not to assign the same frequency to the terminal 1701-2, which may cause strong interference with the base station 1501-1 to which the terminal 1701-1 is connected.

Here, whether or not the interference power is high may be determined based on the RSRP provided in step S1602. Now, the remaining terminal 1701-3 will be discussed. The base station determines that a frequency can be assigned to the terminal 1701-3 because the terminal 1701-3 does not cause substantial interference with the base station 1501-1 and because the terminal 1701-1 also does not cause substantial interference with the base station 1501-3. For this determination, the possibility of causing interference may similarly be determined based on the RSRP.

Thus, based on the temporary assignment results transmitted by the base station 1501, the integration unit 1551 transmits the actual assignment results, that is, information indicative of the assignment of the terminal 1701-1 and the terminal 1701-3, to the base station. Upon receiving the assignment results, the base station 1501 may assign the corresponding frequency to the terminal in step S1607.

Now, a case where the base station includes an AAS will be described.

If the base station includes an AAS, as many terminals as the antennas can be multiplexed. Hence, in an example shown in FIG. 17, even if the terminal 1701-2 is determined to be likely to cause strong interference with the base station 1501-1, the same frequency can be assigned to both the terminal 1701-2 and the terminal 1701-1 provided that the base station 1501-1 includes a 2-antenna AAS. Thus, if any base station includes an AAS, then even with high interference power, the integration unit can determine that the terminal is assignable provided that the number of interference signals is smaller than the number of antennas.

The number of antennas is expected to be constant, and thus, information on the number of antennas may be prestored in the integration unit 1551 or communicated to the integration unit 1551 by the base station 1551 as a message.

Furthermore, if the system is subjected to interference from any terminal connected to a base station unconnected to the integration unit 1551, the integration unit 1551 fails to perform assignment taking the number of antennas in the AAS into account but may use the technique described in the fourth embodiment. Specifically, in communicating the temporary assignment results in step S1604, the base station notifies the integration unit of the last calculated value of a correlation matrix for the PUSCH or assignment results determined from the value of the correlation matrix, and an indicator such as an SINR.

The integration unit knows the last assignment results, and thus, based on the assignment results, can determine whether or not each base station is subjected to interference from a terminal connected to a base station unconnected to the integration unit.

Moreover, the determination process according to the fifth embodiment is wholly carried out by the integration unit 1551. However, the integration unit may collect and transmit information such as the RSRP to the base station 1501, which may perform a part of the determination.

The fifth embodiment described above allows the integration unit to perform the following operation when assigning the same frequency. That is, even if the system is subjected to interference from any terminal connected to a base station unconnected to the integration unit, the integration unit can determine the presence of the interference and achieve terminal assignment taking even the ability of the AAS of each base station into account. This enables resource assignment that can improve the frequency utilization efficiency while avoiding interference.

While certain embodiments have been described, these embodiments have been presented by way of example only, and are not intended to limit the scope of the inventions. Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication method for a first base station and a second base station different from the first base station, comprising:
measuring, by the second base station, a first signal strength intensity of a first data signal transmitted at a first frequency by a first terminal communicating with the first base station, the first signal strength intensity being measured at the second base station;
determining, by the second base station, whether or not the first signal strength intensity is not more than a first threshold and whether or not a second signal strength intensity is not more than a second threshold, the second signal strength intensity being obtained if a second terminal communicating with the second base station receives a reference signal transmitted by the first base station;
transmitting, by the second base station to the second terminal, a first instruction indicating that the second terminal is allowed to transmit a second data signal at the first frequency if the first signal strength intensity is not more than the first threshold and if the second signal strength intensity is not more than the second threshold;
storing the first instruction in an integration unit connected to the first base station and the second base station; and
transmitting, by the integration unit to the second base station, a second instruction indicating that the second terminal is caused to suspend transmission of the second data signal at the first frequency in reference to the first instruction stored in the integration unit if interference occurring in the first base station is not less than a third threshold, the interference occurring as a result of transmission of the second data signal.

2. The method according to claim 1, wherein each of the first base station and the second base station comprises a plurality of antennas, and
if the first signal strength intensity is greater than the first threshold and a number of terminals utilizing the first frequency is smaller than a number of antennas included in the second base station, the transmitting the first instruction transmits the first instruction to the second terminal.

3. The method according to claim 1, wherein each of the first base station and the second base station comprises a plurality of antennas,
the method further comprises determining a number of interference signals at the first frequency in the second base station based on a correlation matrix generated from signals received by the plurality of antennas in the second base station, and
if the first signal strength intensity is greater than the first threshold and the number of interference signals at the first frequency in the second base station is smaller than a number of the plurality of antennas included in the second base station, the transmitting the first instruction transmits the first instruction to the second terminal.

4. The method according to claim 3, wherein the determining the number of interference signals compares a value of a determinant of the correlation matrix with a fourth threshold, and determines that the number of interference signals is smaller than the number of the plurality of antennas included in the second base station if the value is smaller than the fourth threshold.

5. A wireless communication method for a first base station and a second base station different from the first base station, comprising:
Measuring, by the second base station, a first signal strength intensity of a first data signal transmitted at a first frequency by a first terminal communicating with the first base station, the first signal strength intensity being measured at the second base station;
obtaining, by the second base station, a determination result by determining whether or not the first signal strength intensity is not more than a first threshold and whether or not a second signal strength intensity is not more than a second threshold, the second signal strength intensity being obtained if a second terminal communicating with the second base station receives a reference signal transmitted by the first base station;
generating, by the second base station, a temporary assignment result indicative of the second terminal to be assigned to the first frequency based on the determination result;
storing the determination result and the temporary assignment result in an integration unit connected to the first base station and the second base station;
scheduling, by the integration unit, terminal assignments based on the temporary assignment result to generate an assignment result indicative of an actually assigned terminal; and
notifying, by the integration unit, the first base station and the second base station of the assignment result.

6. A wireless communication system comprising an integration unit connected to a first base station and a second base station different from the first base station, and the second base station, the second base station comprising:
a measurement module configured to measure a first signal strength intensity of a first data signal transmitted at a first frequency by a first terminal communicating with the first base station, the first signal strength intensity being measured at the second base station;
a determination module configured to determine whether or not the first signal strength intensity is not more than a first threshold and whether or not a second signal strength intensity is not more than a second threshold, the second signal strength intensity being obtained if a second terminal communicating with the second base station receives a reference signal transmitted by the first base station; and
a generator configured to generate a first instruction indicating that the second terminal is allowed to transmit a second data signal at the first frequency if the first signal strength intensity is not more than the first threshold and if the second signal strength intensity is not more than the second threshold, and
the integration unit comprising:
a storage configured to store the first instruction; and
a notification module configured to transmit, to the second base station, a second instruction indicating that the second terminal is caused to suspend transmission of the second data signal at the first frequency in reference to the first instruction if interference occurring in the first base station is not less than a third threshold, the interference occurring as a result of transmission of the second data signal.

7. The system according to claim 6, wherein each of the first base station and the second base station comprises a plurality of antennas, and
if the first signal strength intensity is greater than the first threshold and a number of terminals utilizing the first frequency is smaller than a number of antennas included in the second base station, the generator generates the first instruction.

8. The system according to claim 6, wherein each of the first base station and the second base station comprises a plurality of antennas,
the second base station further comprises a demodulator configured to determine a number of interference signals at the first frequency in the second base station based on a correlation matrix generated from signals received by the plurality of antennas in the second base station, and
if the first signal strength intensity is greater than the first threshold and the number of interference signals at the first frequency in the second base station is smaller than a number of the plurality of antennas included in the second base station, the generator generates the first instruction.

9. The method according to claim 8, wherein the demodulator compares a value of a determinant of the correlation matrix with a fourth threshold, and determines that the number of interference signal is smaller than the number of the plurality of antennas included in the second base station if the value is smaller than the fourth threshold.

10. A wireless communication apparatus, comprising:
a controller configured to determine whether or not the first signal strength intensity is not more than a first threshold and whether or not a second signal strength intensity is not more than a second threshold, the first signal strength intensity being measured when a first data signal received by the wireless communication apparatus, the first data signal transmitted at a first frequency by a first terminal communicating with a first base station, the second signal strength intensity being obtained if a second terminal communicating with the wireless communication apparatus receives a reference signal transmitted by the first base station; and
a transmitter configured to transmit, to the second terminal, a first instruction indicating that the second terminal is allowed to transmit a second data signal at the first frequency if the first signal strength intensity is not more than the first threshold and if the second signal strength intensity is not more than the second threshold; wherein,
the controller brings the second terminal to suspend transmission of the second data signal at the first frequency if interference occurring in the first base station is not less than a third threshold, the interference occurring as a result of transmission of the second data signal.

11. The apparatus according to claim 10, further comprising a plurality of antennas, wherein
if the first signal strength intensity is greater than the first threshold and a number of terminals utilizing the first frequency is smaller than a number of antennas, the transmitter transmits the first instruction to the second terminal.

12. The apparatus according to claim 10, further comprising:
a plurality of antennas; and
a demodulator configured to determine a number of interference signals at the first frequency based on a correlation matrix generated from signals received by the plurality of antennas, wherein if the first signal strength intensity is greater than the first threshold and the number of interference signals at the first frequency is smaller than a number of the plurality of antennas, the transmitter transmits the first instruction to the second terminal.

13. The apparatus according to claim 12, wherein the demodulator compares a value of a determinant of the correlation matrix with a fourth threshold, and determines that the number of interference signals is smaller than the number of the plurality of antennas if the value is smaller than the fourth threshold.

14. The system according to claim 6, further comprising the first base station.
